(19) United States
(12) Patent Application Publication
(10) Pub. No.: US 2014/0260783 A1
(43) Pub. Date: Sep. 18, 2014

(54) BOLT DAMPING MEMBER

(71) Applicant: CATERPILLAR INC., Peoria, IL (US)

(72) Inventors: Nicholas J. Hoffman, Washington, IL (US); James D. Dunbar, East Peoroia, IL (US); Franklin J. Struwe, III, East Peoria, IL (US)

(73) Assignee: Caterpillar Inc., Peoria, IL (US)

(21) Appl. No.: 13/836,871

(22) Filed: Mar. 15, 2013

(51) Int. Cl. F16B 19/00; F16C 7/00

(52) U.S. Cl. CPC F16B 19/002; F16C 7/00
USPC 74/579 E; 411/508

(57) ABSTRACT

A bolt configured to connect a plurality of sections of a connecting rod assembly is provided. The bolt includes a head portion. The bolt also includes a body extending from the head portion. The bolt further includes a damping member affixed to the body of the bolt. The damping member is configured to dampen vibrational excitation associated with the bolt.

### TECHNICAL FIELD

The present disclosure relates to a damping member for a bolt assembly for a machine component, and more specifically for providing the damping member in order to reduce vibrational excitation associated with the bolt assembly.

### BACKGROUND

Connecting rods used in engines are usually made in sections. The sections of the connecting rod are held together by means of a bolt. The bolt has a natural frequency of vibration. During working of the engine, a frequency of vibration of the engine assembly may match the natural frequency of the bolt. This can result in resonance leading to loosening of the bolt, failure due to fatigue, disengagement of the sections of the connecting rod causing overall damage to the system, and the like.

Methods are known to firmly secure the bolt within the connecting rod. For example, U.S. Published Application Number 2005/262963 discloses a connecting rod having a rod portion, a connecting rod eye and a connecting rod cover. The connecting rod also includes a screw element connecting the connecting rod cover to the rod portion at a region of the connecting rod eye. The connecting rod further includes a securing element disposed in an area between the screw element and one of the rod portion and the connecting rod cover. The securing element braces the screw element with respect to the one of the rod portion and the connecting rod cover.

However the known systems do not have any effect on the frequency of vibration of the bolt. Hence, there is a need to provide an improved design for the bolt in order to dampen the vibrational excitation experienced by the bolt.

### SUMMARY OF THE DISCLOSURE

In one aspect of the present disclosure, a bolt configured to connect a plurality of sections of a connecting rod assembly is provided. The bolt includes a head portion. The bolt also includes a body extending from the head portion. The bolt further includes a damping member affixed to the body of the bolt. The damping member is configured to dampen a vibrational excitation associated with the bolt.

In another aspect of the present disclosure, a connecting rod assembly is provided. The connecting rod assembly includes a connecting rod arm. The connecting rod assembly includes a connecting rod cap. The connecting rod assembly also includes a bolt configured to join the connecting rod arm and the connecting rod cap. The connecting rod assembly further includes a damping member affixed to the bolt. The damping member is configured to dampen a vibrational excitation associated with the bolt.

In yet another aspect of the present disclosure, a method is provided. The method provides a connecting rod arm and a connecting rod cap. The method also provides a bolt for mechanically coupling the connecting rod arm and the connecting rod cap. The method then affixes a damping member to the bolt. The damping member is configured to dampen a vibrational excitation associated with the bolt. The method further receives the bolt affixed with the damping member into the connecting rod arm and the connecting rod cap.

Other features and aspects of this disclosure will be apparent from the following description and the accompanying drawings.

### BRIEF DESCRIPTION OF THE DRAWINGS

FIG. 1 is an exemplary engine assembly, according to one embodiment of the present disclosure;

FIG. 2 is a perspective view of a connecting rod assembly;

FIGS. 3 and 4 are various designs of an exemplary damping member affixed on a bolt, more specifically when the damping member is made of an elastomeric material;

FIGS. 5 and 6 are various designs of another exemplary damping member affixed on the bolt, more specifically when the damping member is made of a malleable metal;

FIG. 7 is a partial sectional view of the connecting rod assembly including the bolt and the damping member; and

FIG. 8 is a method to dampen a vibrational excitation associated with the bolt.

### DETAILED DESCRIPTION

Wherever possible, the same reference numbers will be used throughout the drawings to refer to the same or the like parts. FIG. 1 shows an exemplary engine assembly 100. The engine assembly 100 may correspond to any one or a combination of a spark ignition engine, a compression engine, a liquid-fueled engine, a gas-fueled engine, a dual-fueled engine, or the like. The engine assembly 100 may include a piston 102 configured to oscillate linearly inside a cylinder (not shown). The piston 102 may be connected to a crankshaft 104 through a connecting rod assembly 106. The connecting rod assembly 106 may be configured to convert the linear oscillating motion of the piston 102 to a rotatory motion of the crankshaft 104.

FIG. 2 is a perspective view of the connecting rod assembly 106. The connecting rod assembly 106 includes a connecting rod arm 202. The connecting rod arm 202 includes a first end 204 and a second end 206. The first end 204 includes a first eye 208. The first eye 208 may be configured to pivotally connect the connecting rod assembly 106 to the piston 102 with a gudgeon pin or a wrist pin. The second end 206 has a C-shaped open end 210. A connecting rod cap 212 may be mounted on the second end 206 to form a second eye 214. The connecting rod cap 212 may be fixedly attached to the connecting rod arm 202 at the second end 206, by screw fitting a plurality of bolts 216 in corresponding bores provided in the connecting rod assembly 106. Further, the connecting rod assembly 106 may be pivotally connected to the crankshaft 104 at the second eye 214.

The bolt 216 may possess a natural frequency of its own. During operation of the engine, the natural frequency of the bolt 216 may match to that of the engine assembly 100. This may cause the bolt 216 to vibrate at a resonating frequency leading to resonance. Resonance may cause loosening of the bolt 216 and/or fatigue failure of the bolt 216 over a period of time. Resonance is, therefore, undesirable and detrimental to the bolt 216, the connecting rod assembly 106, and also the engine assembly 100. Hence, resonance needs to be avoided by preventing the bolt 216 from vibrating at the resonating frequency.

The present disclosure relates to a damping member 302 affixed to the bolt 216 as shown in FIG. 3. The bolt 216 may have a head portion 304, a body 306 extending from the head portion 304 and a bottom portion 308. The body 306 may be fully threaded, partially threaded or completely unthreaded as per system design and requirements. The damping member 302 is configured to dampen the vibrational excitation associated with the bolt 216, and thereby prevent resonance. Various configurations of the damping member 302 are illustrated in FIGS. 3 to 6.

More specifically, the damping member 302 may be affixed to the bolt 216 in a variety of ways. For example, the damping member 302 may be externally attached to the body 306 of the bolt 216 or may be integrally molded onto the body 306 of the bolt 216. The bolt 216 and the damping member 302 may be fastened within the bore of the connecting rod assembly 106. The damping member 302 may prevent direct contact of the body 306 with an inner surface of the bore defined in the connecting rod assembly 106. Thus, the damping member 302 may insulate the bolt 216 from the vibrations of the connecting rod assembly 106.

The damping member 302 may be made of any material including any malleable metal, polymer, elastomer or any other damping material known to one skilled in the art. FIGS. 3 and 4 show different designs of the damping member 302 when the damping member 302 is made of the polymeric or the elastomeric material. FIGS. 5 and 6 illustrate various designs of the damping member 302 specifically when the damping member 302 is made of the malleable metal such as, brass, steel and the like.

Referring to FIGS. 3 and 5, the damping member 302 shown is formed in two distinct pieces having a first part 310 and a second part 312. The first part 310 and the second part 312 may have a “C” shaped cross section. As shown in FIG. 4, the damping member 302 may also be formed as a single piece design. Moreover, as shown in FIG. 6, in case of the malleable metal, the damping member 302 could have a hollow cylindrical configuration with a longitudinal slit 602.

Further, one or more raised surfaces may be formed on the damping member 302. For example, the damping member 302 may have a ringed configuration in the form of rings 314 (as shown in FIGS. 3 to 5) and/or protrusions 604 (as shown in FIG. 6). The spacing between the rings 314 and/or the protrusions 604 may vary based on the application. In another embodiment, the damping member 302 may have a helical configuration. In yet another example, the damping member 302 may have a smooth outer surface.

The rings 314 on the damping member 302 made of the elastomeric material may be formed by molding. It should be noted that use of the polymeric or elastomeric material include ability to create finer configurations on the damping member 302 like close spacing of the rings/helix to each other, ability to easily fit into the bore of the connecting rod assembly 106, etc. The rings 314 and the protrusions 604 on the damping member 302 made of the malleable metal may be formed by stamping or any other known process.

As shown in FIGS. 3 and 5, the damping member 302 may be fastened to the bolt 216 by snapping or clamping the damping member 302 on the body 306. Alternatively, the damping member 302 may be fastened on to the body 306 by winding a wire or an elastic band or the like in order to temporarily hold the damping member 302 on the body 306 until installation within the connecting rod assembly 106. In one embodiment, the damping member 302 may be attached to the body 306 by using a suitable adhesive. The single piece design of damping member 302, shown in FIG. 4, may be slid over the body 306 before assembly. The damping member 302 may also be molded over the body 306 by placing the body 306 in a mold and then molding the damping member 302 over the body 306.

Further, the damping member 302 may be located anywhere along the body 306. Preferably, the damping member 302 should be provided proximate to the head section 304 of the bolt 216. For example, the damping member 302 may be provided in a first half section or a first quarter section of the body 306 proximate to the head section 304 of the body 306. Additionally, a second damping member 302 may be provided in a second half section or a second quarter section of the body 306 proximate to the bottom section 308 of the body 306. Also, the damping member 302 may be placed either over an unthreaded or threaded portion of the body 306.

It should be noted that the materials for the damping member 302 and the configurations may be varied and may be interchanged without deviating from the scope and spirit of the disclosure. The designs shown herein are merely exemplary and do not limit the scope of the disclosure. Moreover, dimensional parameters of the damping member 302 like length, thickness, type of configuration formed on the inner and/or the outer surface and the location and number of the damping members 302 that may be used on the body 306 of the bolt 216, may vary as per system design and requirements and may not limit the intended scope of the disclosure.

FIG. 7 shows a partial sectional view of the connecting rod assembly 106. The partial sectional view includes the connecting rod cap 212 having a bore 702. The bolt 216 along with the damping member 302 affixed to the body 306 and an optional washer 704 may be inserted within the bore 702. The damping member 302 may create a force fit or an interference fit with the bore 702. For example, when the damping member 302 is made of the elastomeric material, an outer diameter of the damping member 302 may be greater than a diameter of the bore 702, creating the interference fit between the damping member 302 and the bore 702. Further, when the damping member 302 is made of the malleable metal, the outer diameter of the damping member 302 may be smaller than the diameter of the bore 702, creating the force fit between the damping member 302 and the bore 702.

### INDUSTRIAL APPLICABILITY

Bolts used to join the sections of the connecting rod assembly possess natural frequencies of their own. During operation of the engine, the energy and vibrations of the system get transferred to the bolts through the connecting rod. This transfer of energy and vibrations may cause the bolts to vibrate at resonating frequencies. These resonating frequencies are detrimental and undesirable as they may lead to loosening of the bolts, structural fatigue failures of the bolts, and the like causing catastrophic damage to the overall engine assembly.

The present disclosure relates to the damping member 302 that may be used to prevent the bolt 216 from vibrating at the resonating frequency and prevent failure of the bolt 216. The damping member 302 may be affixed to the body 306 of the bolt 216. This may lead to reduced strain in the bolt 216 in order to have an acceptable fatigue life. The damping member 302 may result in a considerable increase in a fatigue factor of the bolt 216, thereby resolving field failures.

Referring to FIG. 8, at step 802, the connecting rod arm 202 and the connecting rod cap 212 is provided. At step 804, the bolt 216 is provided for mechanically coupling the connecting rod arm 202 and the connecting rod cap 212. At step 806, the damping member 302 is affixed to the body 306 of the bolt 216. Moreover, the body 306 may be partially threaded, fully threaded or fully unthreaded. The damping member 302 may be affixed to the body 306 by any known method of fastening like snapping, clamping, sliding, adhesion by the suitable adhesive, tying with a wire, string, etc. The location of the damping member 302 may be anywhere along the length of the body 306, but may be preferably located proximate to the head section 304 of the bolt 216.

After affixing the damping member 302 over the body 306 by an appropriate fastening method, at step 808, the bolt 216 along with the damping member 302 and the washer 704 may be received in the bore 702 of the connecting rod assembly 106.

The thickness of the damping member 302 may be so selected so as to create the force fit or the interference fit, as per system design and requirements. The damping member 302 may rest between the bore 702 and the bolt 216. Hence, the damping member 302 may insulate the bolt 216 from the energy and vibrations of the connecting rod assembly 106. This in turn, may prevent the bolt 216 from vibrating at detrimental and undesired resonating frequency.

It should be understood that apart from the bolt 216 installed on the connecting rod assembly 106, the damping member 302 may be used on fastening members used on a variety of other applications. Fastening members may include screws, rivets, clamps, etc. used on various industrial and commercial machines, vehicles and the like which are subjected to detrimental vibrations during their operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A bolt configured to connect a plurality of sections of a connecting rod assembly, the bolt comprising:
a head portion;
a body extending from the head portion; and
a damping member affixed to the body of the bolt, the damping member configured to dampen a vibrational excitation associated with the bolt.

2. The bolt of claim 1, wherein the damping member is made of an elastomeric material.

3. The bolt of claim 2, wherein the damping member is molded onto the bolt.

4. The bolt of claim 1, wherein the damping member is made of a malleable metal.

5. The bolt of claim 4, wherein the damping member includes a hollow cylindrical configuration having one slit.

6. The bolt of claim 1, wherein the damping member includes a first part and a second part, wherein the first part and the second part have a “C” shaped cross section.

7. The bolt of claim 1, wherein the damping member is affixed proximate to the head portion of the bolt.

8. The bolt of claim 1, wherein an outer surface of the damping member includes a plurality of raised surfaces.

9. The bolt of claim 1, wherein an outer surface of the damping member includes a helical shaped configuration.

10. A connecting rod assembly comprising:
a connecting rod arm;
a connecting rod cap;
a bolt configured to join the connecting rod arm and the connecting rod cap; and
a damping member affixed to the bolt, the damping member configured to dampen a vibrational excitation associated with the bolt.

11. The connecting rod assembly of claim 10, wherein the damping member is made of an elastomeric material.

12. The connecting rod assembly of claim 11, wherein the damping member is molded onto the bolt.

13. The connecting rod assembly of claim 10, wherein the damping member is made of a malleable metal.

14. The connecting rod of claim 13, wherein the damping member includes a hollow cylindrical configuration having one slit.

15. The connecting rod assembly of claim 10, wherein the damping member includes a first part and a second part, wherein the first part and the second part have a “C” shaped cross section.

16. The connecting rod assembly of claim 10, wherein the damping member is affixed proximate to a head portion of the bolt.

17. The connecting rod assembly of claim 10, wherein at least a first damping member is affixed proximate to a head portion and at least a second damping member is affixed proximate to a bottom portion of the bolt.

18. The connecting rod assembly of claim 10, wherein an outer surface of the damping member includes a plurality of raised surfaces.

19. The connecting rod assembly of claim 10, wherein an outer surface of the damping member includes a helical shaped configuration.

20. A method comprising:
providing a connecting rod arm and a connecting rod cap;
providing a bolt for mechanically coupling the connecting rod arm and the connecting rod cap;
affixing a damping member to the bolt, the damping member configured to dampen a vibrational excitation associated with the bolt; and;
receiving the bolt affixed with the damping member into the connecting rod arm and the connecting rod cap.
